(19) United States
(12) Patent Application Publication
(10) Pub. No.: US 2001/0022218 A1
(43) Pub. Date: Sep. 20, 2001

(54) Side window roll-up blind

(76) Inventors: Werner P. Schlecht, Vaihingen (DE); Holger Seel, Aidlingen (DE); Herbert Walter, Ebersbach (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 09/779,728

(22) Filed: Feb. 8, 2001

(30) Foreign Application Priority Data
Feb. 9, 2000 (DE) 10005970.8

(51) Int. Cl. B60J 1/20

(52) U.S. Cl. 160/370.22

(57) ABSTRACT

A side window roll-up blind for motor vehicles has a winding shaft which is rotatably supported preferably behind the side lining of the door or of the B-column (3). Through a slot in the door (7), a blind material (31) can be drawn out, which covers the window (21). For this purpose, an actuating member engages on the edge of the blind material (31) that covers the furthest distance. The actuating member is a linear-form element which, depending on the embodiment, is either pull-resistant or pressure-resistant. The blind material (31) itself can be held clamped-open beside the window with the aid of at least one guide rail or of one or two pressure-resistant or bending-resistant actuating members.

### FIELD OF THE INVENTION

The invention generally relates to roll-up blinds for the windows of an automobile.

### BACKGROUND OF THE INVENTION

A large number of solutions are known in order to drive or reel in and out by electrical remote control a window roll-up blind present in the rear window of a passenger vehicle.

One solution is shown, for example, in EP-C-0 240 747, in which for clamping bending-resistant levers are used exclusively. The known rear window roll-up blind has a base in which a winding shaft is rotatably borne. The winding shaft is pre-stressed in a wind-up direction of a blind material with the aid of a spring motor. One edge of the blind material is mounted on the winding shaft. The other edge is connected with a pull rod on which there engage two one-armed levers that are borne on the base. The bearing axes of the levers run at a right angle to the winding shaft. In the moving-up of the levers, the blind material is drawn off from the winding shaft.

In passenger cars, however, sunlight enters not only through the rear window but also through the side windows. The rear passengers being in general more frequently exposed to light coming in over the side windows, because the window edge throws no sufficient shadows, since the window edge of the side windows is immediately adjacent to the rear passengers.

Therefore, a need exists for a simple-to-operate roll-up blind for the side windows, especially for the rear side windows of a motor vehicle.

Certainly, the side window roll-up blind is substantially more complicated in its mechanical formation than a rear window roll-up blind where the blind course has in general a symmetrical, trapezoidal or rectangular cut-out. For the side windows, such simple cut-outs cannot be used, since the contour of the side window is relatively complicated and appropriately the entire window surface is to be shaded off.

### OBJECTS AND SUMMARY OF THE INVENTION

Accordingly, in view of the foregoing, a general object of the present invention is to provide an electrically operable side window roll-up blind.

In the side window roll-up blind of the invention there is provided a rotatably borne winding shaft, to which the cut-out of the blind material is fastened with a border portion. An actuating element engages on another portion of the blind material lying away from this first portion in order to draw the blind material off from the winding shaft and to hold it in the clamped-open state. For the reeling in and out of the blind material a power-actuated drive mechanism is used.

In this manner, for example, the side window roll-up blind concerned can be controlled from the driver's side. Also the rear passengers have a simple possibility for moving the side window roll-up blind up and down. Moreover, the new construction makes it possible for the side window roll-up blind to largely disappear inside the door or behind the door lining. In the reeled-in state, it is virtually completely withdrawn behind the contours of the window. No parts such as grip latches and the like protrude, which would otherwise be necessary for manually operated side window roll-up blinds.

Depending on the space relations and on the particular car body form, the winding shaft can be arranged vertically, in the B-column for example, in the door frame profile in the vicinity of the B-column of a passenger car, or parallel to the lower edge of the side windows. These two edges are independent from the car body shape and in general largely straight, while the other edges of the window, depending on the car body shape, are more or less strongly curved, which makes an accommodation of the winding shaft difficult.

The mounting of the winding shaft underneath the lower window frame edge makes it possible, furthermore, to accommodate the winding shaft in the region of the door, which in today's vehicles has available a lot of empty volume inside the door.

In order to keep the blind material free from fluttering and vibrating in the clamped-open or reeled-out state, and also to guide it during the reeling-out movement, there are two possible solutions.

The first solution provides at least one guide rail that runs parallel to one border of the window. With the aid of this guide rail, a section of the blind material lying away from the winding shaft is guided in a captive state.

The other possibility lies in using as an actuating mechanism substantially bending-resistant thrust members in order to draw the blind material off from the winding shaft. The thrust members engage on the edge of the blind material that covers the greatest distance in the reeling in and out. There, at least during the unwinding process, the front edge of the blind material is guided exclusively by the thrust members and held in transverse direction. The thrust members, therefore must be sufficiently rigid at least in a plane that is defined by the clamped-open or reeled-out blind. In the direction parallel to this, guiding is provided largely by the blind material itself in conjunction with the pre-stressing, thus a special resistance to bending in this direction is not absolutely required.

In the completely clamped-open or reeled out state, the upper edge of the blind material cut-out can be received in hook-shaped pockets. These pockets prevent vibrations of the upper edge of the clamped blind material caused by jolting of the vehicle. Such vibrations can also be largely avoided if the thrust members are directed in such manner that in the reeling-out of the blind the upper edge of the blind material slides out along the inner side of the pane because it is pressed onto the disk.

A very stable guidance of the blind material is produced if the blind material is guided between two guide rails which run about in the same direction, starting from the winding shaft. Since these guide rails do not run parallel to one another because of the side window geometry, the blind material contains at least one tilt holder that is adjustable lengthwise. The tilt holder adapts itself therewith automatically to the changing distance between the guide rails.

The upper or side edge of the blind material can also be taken up on an arm which is fastened to a sliding element running in the guide rail. The arm runs parallel to the edge concerned of the window and leads the respective edge of the blind material practically over its entire length.

Bending of the blind material can be avoided if the arm is constructed as a rail in which the respective blind material edge is slidably received.

In order to make the actuation and control of the blind material as simple as possible, the drive mechanism of the side roll-up blind of the invention comprises at least one electric motor as well as spring element. Between the electric motor and the spring element the blind material lies kinematically, the drive motor defining the position of the upper edge and side edge of the blind, while the spring element as a “slave drive” provides for the pre-stressing in the blind.

Depending on installation relations, the electric motor can cooperate with the winding shaft or with the part of the blind that covers the greatest distance in the reeling out, while the spring element in each case engages on the other end of the blind material. When the electric motor is operationally joined directly with the winding shaft, the part of the blind that covers the greatest distance is joined with a traction spring, over the actuating mechanism which is in the form of cables. This permits, inter alia, compensating for different running distances of the actuating means in a simple manner if, for example, one actuating mechanism runs in a straight- and the other in a curved guide rail.

In the other embodiment, the spring is seated as spring motor in the winding shaft while, over actuating members, the electric motor is coupled with the blind material and, namely, again with the part of the blind material which covers the greatest distance in the reeling-up and reeling-out.

Depending on the installation relations, the actuating members can act as thrust members or as pull members. In both cases, Bowden controls can be used, with which in the case of pressure members the core of the Bowden control is or must be guided correspondingly pressure-rigidly.

At least one end the linear actuating members are provided with a type of indentation with which they engage in closed form into an output gear wheel of the drive motor. Such actuating members are commercially available under the trade designation “Su-flexwelle”, and they consist of a wire core running in longitudinal direction, on the outer circumferential surface of which there is applied a screw likewise formed from a wire. The distance between adjacent turns of the screw corresponds to the thickness of the tooth of the drive gearwheel. In order to avoid clapping noises, brushes can be present between the wire turns of the screw, which give the arrangement the appearance of a bottle brush.

These and other features and advantages of the invention will be more readily apparent upon reading the following description of the preferred exemplary embodiments of the invention and upon reference to the drawings wherein:

### BRIEF DESCRIPTION OF THE DRAWINGS

FIG. 1 is a partially cut away perspective view of the rear area of an illustrative passenger car having a side window roll-up blind in accordance with the invention.

FIG. 2 is a partially cut away front elevation view of the rear right side door of FIG. 1 showing the side window roll-up blind.

FIG. 3 is a schematic, partially exploded perspective view of the side roll-up blind of FIG. 2.

FIG. 4 is a schematic, partially cut away of an exemplary automobile side door showing an embodiment of the side roll-up blind of the present invention that does not have guide rails.

FIG. 5 is a schematic front elevation view of an embodiment of the side roll-up blind of the present invention which has two guide rails.

FIG. 6 is a schematic front elevation view of the tilt holder showing its reception in the guide rails.

FIG. 7 is a front elevation view of an embodiment of the invention similar to that shown in FIG. 5, but with a vertically arranged winding shaft,

FIG. 8 is a schematic, partially cut away perspective view of the lower guide rail of the embodiment of FIG. 7.

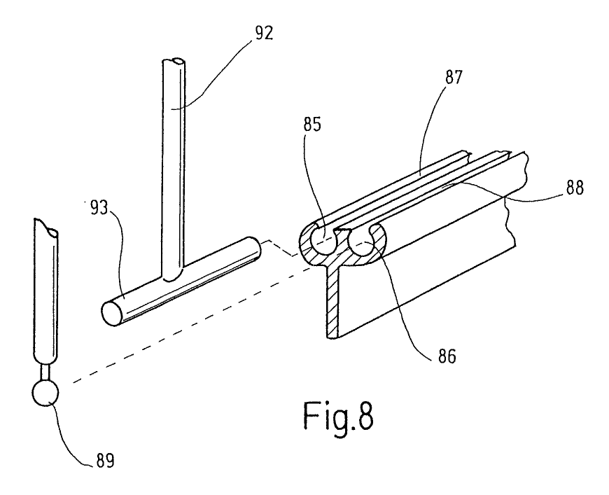

FIG. 9 is a schematic front elevation view of an embodiment of the side roll-up blind according to the invention which has a flexible reinforced a blind material edge.

FIG. 10 is a schematic partially exploded perspective view of an embodiment of the invention similar to that according to FIG. 3.

While the invention will be described and disclosed in connection with certain embodiments and procedures, it is not intended to limit the invention to those embodiments. Rather, it is intended to cover all such alternative embodiments and modifications as fall within the spirit and scope of the invention.

### DETAILED DESCRIPTION OF PREFERRED EMBODIMENTS

In the following description of the figures terms such as “front”, “rear”, “above” or “below” as well as terms with similar signification, inclusive of the terms “right” and “left” are used in the manner in which they are normally used for designation of directions in a motor vehicle.

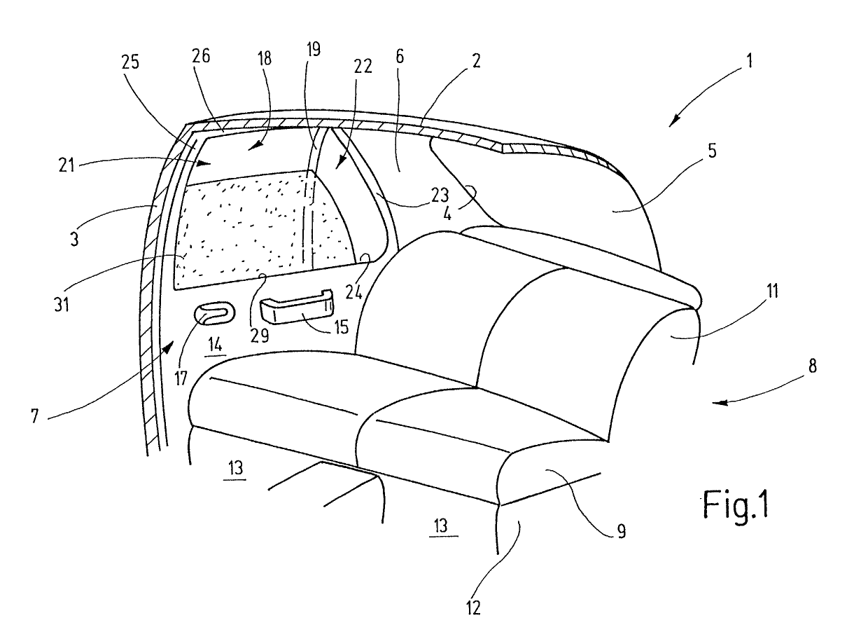

FIG. 1 represents the broken-open, cut-off rear area of a passenger car. The figure illustrates a view of the right inside which is in mirror image to the non-illustrated left inside. The representation is also simplified. Thus, for example, car body interior structures, such as reinforcement and fastening means, are not shown, since their representation is not required for an understanding of the invention.

The illustrated car body section 1 has a roof 2 from which a B-column 3 leads laterally downward of a floor group (not shown). A corresponding B-column could be arranged on the broken-away side of the vehicle. The roof 2 goes over on its rear edge into a rear window opening 4, in which there is installed a rear window pane 5. Laterally, the rear window opening 4 ends on a C-column 6 which is arranged at a distance from the B-column 3. Between the B-column 3 and the C-column 6, a right side door is hinged in a known manner.

At the height of the right rear side door 7, a rear seat bench 8 is provided which includes a seating surface 9 as well as a rear seat back 11. The rear seat surface 9 lies on a base surface 12 which belongs to the floor group and in which foot spaces 13 are formed in front of the rear seat surface 9.

The inner side of the side door 7 facing the interior space is provided with an inner lining 14, to which a door grip 15 is fastened and in which an operating handle 17 is admitted in order to open the lock of the side door 7.

The side door 7 contains a window opening 18 above the inner lining 14 which is divided by an partition 19 into two sections 21 and 22. The section 22 has an about triangular shape and is bounded in front by the partition 19 and to the rear by a rear frame section 23 of the door as well as by a lower window frame section 24. In the side window cut-out 22, a window pane is firmly and immovably installed.

The window cut-out 21 has in the broadest sense a rectangular shape. It is bounded in front by a front frame section 25, above by an upper frame section 26, to the rear by the partition 19 and below by the already-mentioned lower window frame section 24. The front frame section 25 as well as the partition 19 contain, in a known manner, guide rails in which a side window pane is slidably guided. The partition 19, which extends from the upper frame section 26 to the lower window frame section 24, runs, therefore, substantially parallel to the front frame section 25, at least parallel to the guide rail present there.

The side window pane cannot be seen in FIG. 1. This window pane is lowerable in the known manner between the outer sheet metal skin of the side door and the inner door shell. A drive mechanism is also allocated to it in order to move the window pane up and down.

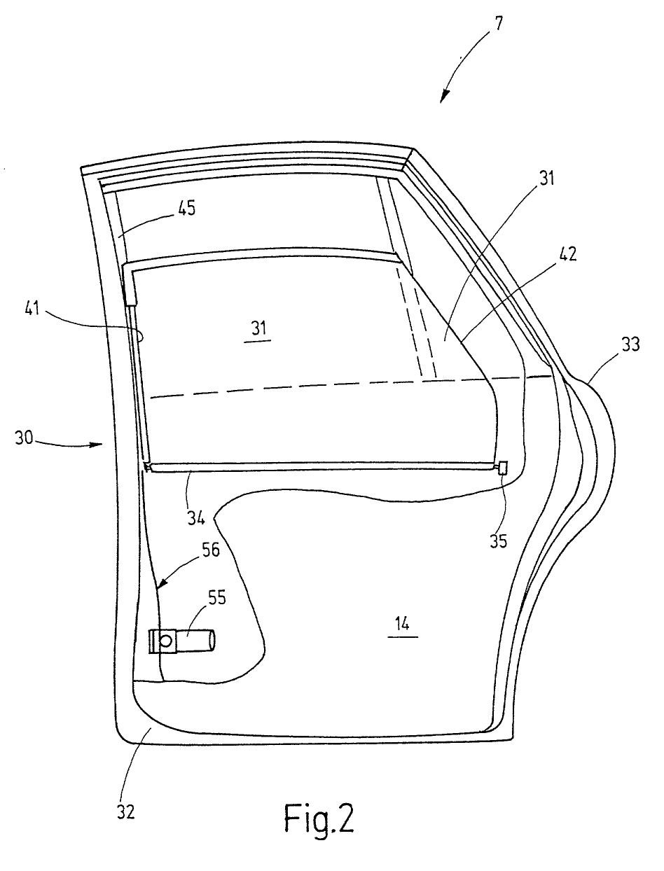

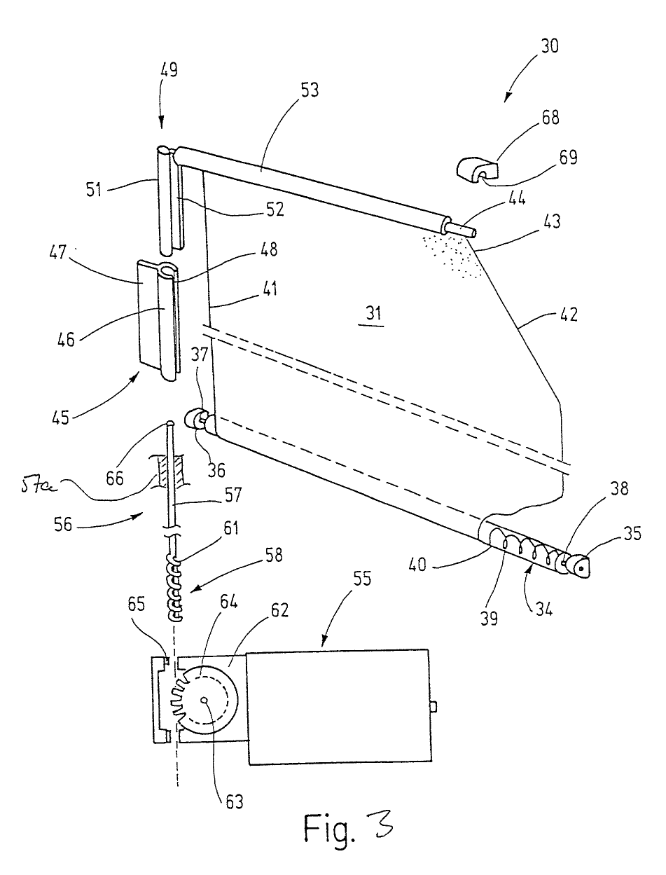

The side door 7 is provided with a side window roll-up blind 30, represented in detail in FIGS. 2 and 3, the blind material 31 is partly reeled out in the representations of FIGS. 1 and 2, in order in this way to protect the rear zone of the passenger cabin against lateral irradiation of sunlight. The blind material 31 runs out through a slot 29 disposed beside or underneath the lower window frame section 24. The slot is located in the inner lining 14 or between the inner lining 14 and the inner shell of the door.

In FIG. 2, the side door 7 is separately depicted. In FIG. 2 there can be seen a hinged door frame 32, sections of the door skin 33 consisting of sheet metal, as well as the inner lining 14 shown broken-open, which is located on the inner shell of the door 7.

The side window roll-up blind 30 includes a winding shaft 34 which is borne on the door 7 underneath the window lower edge 32 behind the inner lining 14. For the winding shaft the door 7 carries, spaced from one another, two bearing blocks 35 and 36 which receive bearing pins 37 and 38, which project axially from the tubular winding shaft 34. A schematically shown spring motor 39 is present in the winding shaft which, at 40, is firmly joined with the winding shaft 34, and the other end of which is untwistably coupled with the bearing pin 38. The bearing pin 38, in turn, is seated untwistably in the bearing block 35. The spring motor 39 forms a part of the drive arrangement of the side window roll-up blind 30, and it generates a pre-stressing force onto the winding-shaft 34, in the direction of a winding-up or reeling-up of the blind material 31. The blind material 31 is fastened to the winding shaft 34, for example, in a known manner by means of a piping.

The blind material 31 consists of a cut-out from a plastic foil which sufficiently shields off the sunlight. The outer contour corresponds to the outer contour of the window opening 18, i.e. to the sum of the two window openings 21 and 22.

The blind material 31 is bounded by a front straight edge 41 lying in a traveling direction, a rear contoured edge 42 as well as by an upper edge 43 and an edge (not seen) fastened to the winding shaft 34.

On the upper edge 43 of the blind material, a border reinforcing strip 44 is mounted which extends from the rear edge 42 to the front edge 41.

The side window roll-up blind 30 further includes a guide rail 45, which is fastened to the door 7 in the area of the front window frame section 25 and extends from the upper window frame 26 into the interior of the door 7.

In FIG. 3, only a section of the guide rail can be seen. The guide rail 45 is composed of a C-shaped profile piece with a back-gripping guide groove 46 and a molded-on strip-form fastening flange 47. The guide groove 46 opens on a slot 48 which lies opposite and faces away from the flange 47.

A slide 49 runs in the guide rail 45 which consists of a base body 51 mounted on the interior of the guide groove 46, from which base body 51 there proceeds a strip-form flange 52, which extends through the slot 48 to the outside. In the simplest case, the base body 51 is essentially cylindrical and the interior of the guide groove 49 of the guide rail 45 is likewise cylindrical.

An extension 53 is fastened to the flange 52 which stands off from the base body 51 essentially at a right angle and, on its part, has the form of a guide rail, in which the border reinforcement strip 4 is received longitudinally slidably. The extension 53 is formed in such manner that the border reinforcement strip 44 has only one degree of freedom, namely in a direction parallel to the lengthwise extent of the extension 43. In the direction perpendicular thereto, it is bound in the extension 53.

In order to reel in and reel out the side window roll-up blind at will, the drive arrangement includes in addition to the spring motor 39 a gear motor 55 which is coupled with the slide 49 over an actuating member 56. The actuating member 56 is formed by a pressure-resistant, linear element, for example a flexible metal or plastic wire 57, the core of a Bowden control or of a thrust resistant, cabled wire strand. At least on the motor-side end, the actuating member 56 carries on its outer peripheral surface a wire coil 61 forming a screw or worm 58, which is bound unshiftably with the actuating member 56. Actuating members of this type are available under the trade name “SU-flexwelle” and are used, inter alia, in sash lifters.

The drive motor 55 is a permanently energized direct current motor, having a reducing gear 62 on the outlet side. A face gear wheel 64 is untwistably seated on an output shaft 63 of the gear 62, the division of which agrees with the division of the worm or screw 58.

Beside the face gearwheel 64, the housing of the gear contains a guide 65 which is designed in such manner that it leads the screw 58 of the actuating member 56 tangentially to the output gearwheel 64 and causes the teeth of the face gear wheel 64 to engage in closed form between the turns of the screw 58.

The actuating member 56 operatively connects the face gearwheel 64 with the slide 51 and, namely, proceeding from the gear 62 or from the guide 65 present there it is led pressure rigidly in a sleeve 57a to the lower end of the guide rail 45. At this location, the actuating member 56 enters into the interior of the guide groove 46. The free end 66 of the actuating member 56 lies free abutting on the lower end of the guide slide 51.

In the installed state, with side window roll-up blind 30 opened, virtually no parts of this can be seen. The guide rail 45 runs beside the window guide and thus largely disappears in the window frame lining of the door 7. It would then be possible to perceive only the extension 53 in a slot 29 which is bounded on the one hand by the inner lining 14 and, on the other hand, by the lower window frame section 24, and through which the side window roll-up blind 30 is reeled out from the door interior.

The handling and functioning of the side window roll-up blind described is as follows:

In the rest state, the blind material 31, under the action of the spring motor 38, is wound onto the winding shaft 34. The slide 51 has traveled downward in the guide rail 45 until the extension 53 fills out the earlier mentioned blind slot 29 corresponding to the length of the extension 43.

If, proceeding from this operating position, the user wishes to reel out the side window roll-up blind 30, then, using an electric switch (not further shown), he sets the drive motor 55 in operation and, namely, in a turning direction such that the face gear wheel 64 pushes forward the pressure-resistant or pressure-resistantly guided actuation member 56 in the direction toward the guide rail 45. In this forward-feed movement, the actuating member 56 guided in the interior of the guide rail 45 pushes the guide slide 49 guided in the interior of the guide rail 45 upward, together with the extension 53 fastened to it, in the direction of the upper window frame section 26. There correspondingly the blind material 31 is unwound from the winding shaft 34 and drawn upward through the blind slot 29 in the door 7.

As soon as the slide has arrived at the upper end of the guide rail 45 and strikes against corresponding boundary stops, the motor current rises. This process is evaluated in a known manner by a monitoring circuit known per se, in order to switch off the current to the drive motor independently from the switch control by the user. The arrangement further provides, in a known manner, to permit a re-engaging of the motor current only for the reverse turning direction.

The blind material 31 is now completely reeled out and the extension 53 abuts on the upper window frame edge 26. The blind material 31 is clamped open in front of the entire window surface.

Even if the angle between the guide rail 45 and the axis of the winding shaft 34 does not amount to 90°, no tension forces can arise in the blind material 31, because the border reinforcing strip 44 can slide lengthwise in the extension 53.

Vibration of the extension 53 can be avoided with the side window roll-up blind reeled out if, corresponding to the upper end position on the inside of the door 7, a hook-shaped pocket 68 is fastened which has a downward-open groove 69. The groove 69 takes up the extension 43 in the upper end position at a point that is distant from the slide 51. Oscillating movements of the extension 53 about the longitudinal axis of the slide 49 are thereby precluded with certainty.

For the reeling-in of the side window roll-up blind 30, the user sets the electric motor 55 in operation over a corresponding switch in the opposite turning direction. The face gear wheel 54, which meshes with the screw 58, draws the actuating member 56 back downward from the guide rail 45, whereby the advancing force acting against the slide 49 abates. The spring motor 38 is then able correspondingly to the yielding of the actuating member 56, to rewind the blind material 31 onto the winding shaft 34.

The lower end position of the actuating member can be asked for in a similar manner as its upper end position, and halted in a corresponding manner.

As is evident, the blind material 31 is held taut by the action of the spring motor 38, while the position is given by the self-inhibitively active drive motor 55.

As is yielded from the explanation, the spring drive 39 could also change places with the drive motor 55 in such manner that the drive motor 55 drives the winding shaft 34 in positive engagement, while the actuating member 56 is acted upon by a pressure spring or such a spring is replaced. In such an embodiment, the slide 51 would be prestressed in the unwinding direction, while the blind material 31 is wound upon against the action of the spring on the winding shaft 38.

It would also be possible, finally, to use as actuating member 56 a cable which is fastened at one end to the slide 49 and at the other end to a pull spring. The pull spring would likewise tend to draw the slide 49 upward, over the cable, in which case the movement would be either inhibited or permitted by the interplay of the winding shaft 34 with the drive motor 55.

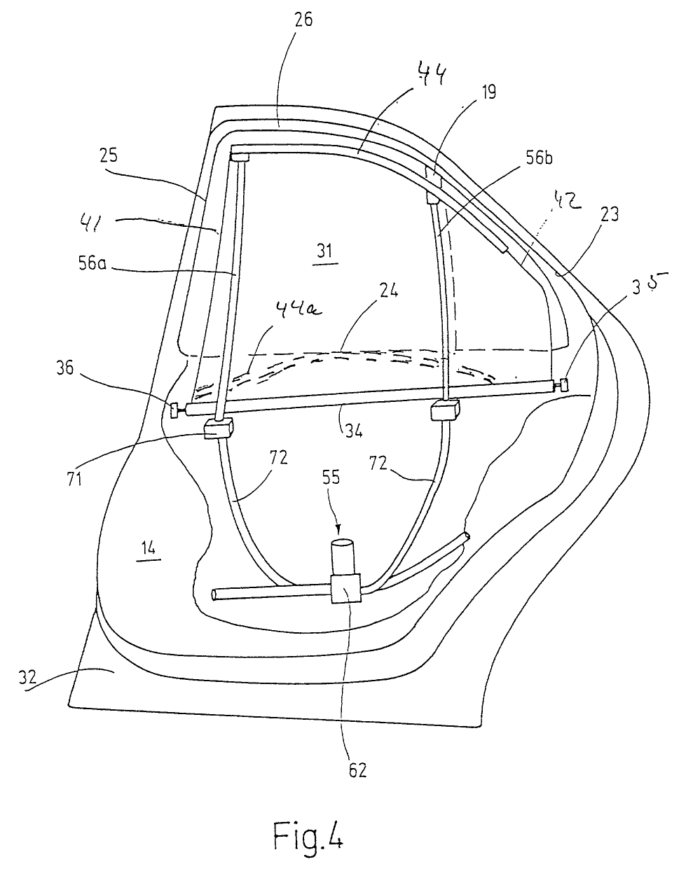

In the earlier-described embodiment the side window roll-up blind 30 has a single guide rail 45. In FIG. 4 there is shown, highly schematized, an embodiment in which the side window roll-up blind 30 is free from guide rails.

As before, the winding-shaft 34 is rotatably borne underneath the lower window frame edge 24, behind the inner lining 14. As described before, the blind material 31 the cut-out of which is shown formed about as in FIG. 3 is fastened at one edge to the shaft.

Underneath the winding shaft 34, two slide guide blocks 71 are fastened. From each of the slide guide blocks 71, a pressure-resistant and relatively bending-resistant cylindrical actuating member 56a and 56b arises. The lower ends of the two actuating members 56a and 56b are designed in the same way as is explained in connection with FIG. 3 and they run, proceeding through guide blocks 71, through guide tubes 72 to the drive motor 55 and into its gear 62. Since both actuating members 56 are driven by the same face gearwheel 64, they run necessarily at the same speed and with the same stroke, i.e. exactly synchronously to one another.

The actuating member 56b lies in front of the partition 19.

The free ends of the actuating members 56a and 56b are directly connected with the reinforcing strip 44.

In the traveling-out, the actuating members press the reinforcing strip 44 upward thus unwinding the blind material from the winding shaft 34 against the action of the spring motor in the winding shaft 34.

The part of the actuating members 56a and 56b emerging from the slide guide blocks 71 is a relatively rigid plastic or metal wire which, on the one hand, can follow the arcuate course of the guide tubes 72, but is capable of carrying the reinforcing edge strip 44 of the blind material 31.

The free ends of the actuating members 56a and 56b are inseparably joined with the edge reinforcement strip 44.

Since the edge reinforcement strip 44 in the illustrated embodiment shown runs with a relatively strong curvature and cannot be wound on the winding shaft 34, the winding shaft 34 is retracted with respect to the lower window edge 24. The offset has the length of a projection of the ends of the edge reinforcement strip 44 onto a straight line that lies at a right angle to the winding shaft 34 and in the plane of the blind material 31.

The functioning of the side window roll-up blind 30 according to FIG. 4 is similar to that in the earlier-explained side window roll-up blind 30 according to FIGS. 1 to 3. The sole difference lies in that the edge reinforcing strip 44 is borne and guided exclusively by the actuating members 56a and 56b. It is obvious that these actuating members 56 run parallel to one another in the reeled-out state.

So that in the reeled-out state the upper edge of the blind material does not start vibrating by reason of the unavoidable occurring jolting, one or two receiving pockets 68 can be provided, as they were shown in FIG. 3 and also described in connection with FIG. 3.

The winding-up of the blind material 31 on the winding shaft 34 takes place as described above, for example with the aid of a spring motor accommodated in the winding shaft 34.

If the upper edge of the blind material 31 is severely curved in correspondence to the form of the window, the winding shaft 34 is correspondingly accommodated far below in the door 7. The distance of the winding shaft 34 from the window lower edge 24 is dimensioned as follows:

The ends of the reinforcing strip 44 are projected onto a straight line that lies in the plane of the blind material 31 and stands vertically on the winding shaft 34. The interval marked off hereby on this straight line is the measurement by which the winding shaft 34 is lowered below the window edge 24.

If this distance should be too great, there is also the possibility of winding the blind material 31 on the winding shaft 34 in truncated conical form—i.e. in order to take care that the blind material edge with which the respective end of the reinforcing strip 44 is at the greatest distance from the winding shaft 34, is wound on a greater diameter of the winding shaft 34, as compared with the oppositely lying edge, at which the distance between the free end of the reinforcing strip 44 and the winding shaft 34 is shorter. The two actuating members 56a and 56b here must cover different distances. They must, proceeding from their starting position, reach their upper end position after the same amount of time, which means that they must move at different speeds.

The speeds stand in a fixed constant relation to one another. They can be realized as the gear motor 55 receives separate gear wheels for the two actuating members 56a and 56b, similar to the gear wheel 64, according to FIG. 3, with diameters that are adapted to the different relative speeds.

In the reeled-in state, with optimal formation the ends of the reinforcing strip 44 reach the circumference of the winding generated on the winding shaft 34 from the blind material 31 at the same point in time, as is schematically indicated by the reinforcing strip 44a drawn in broken lines in FIG. 4.

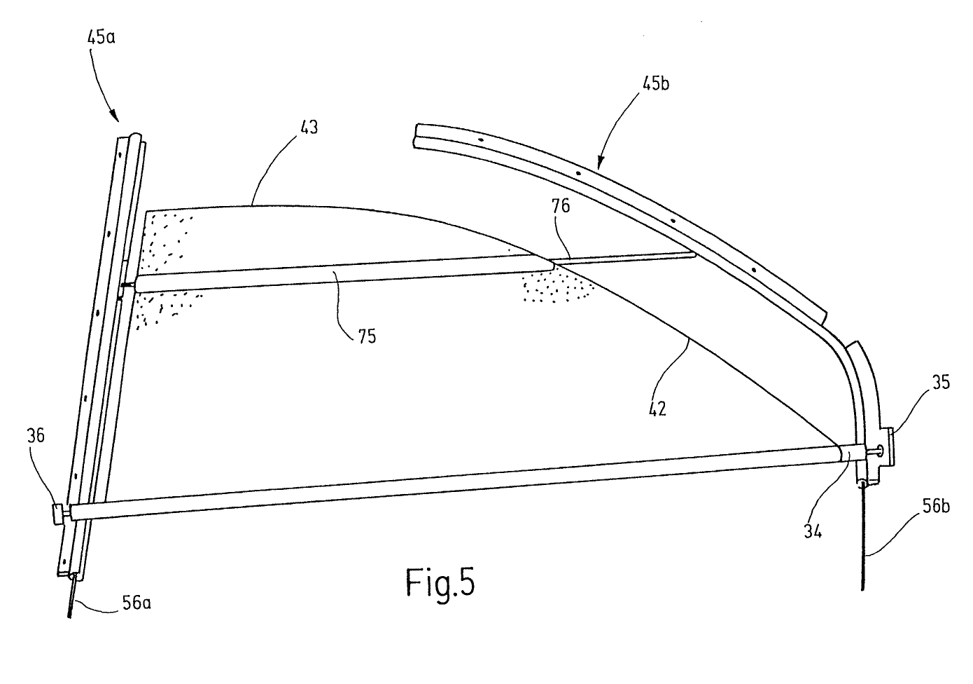

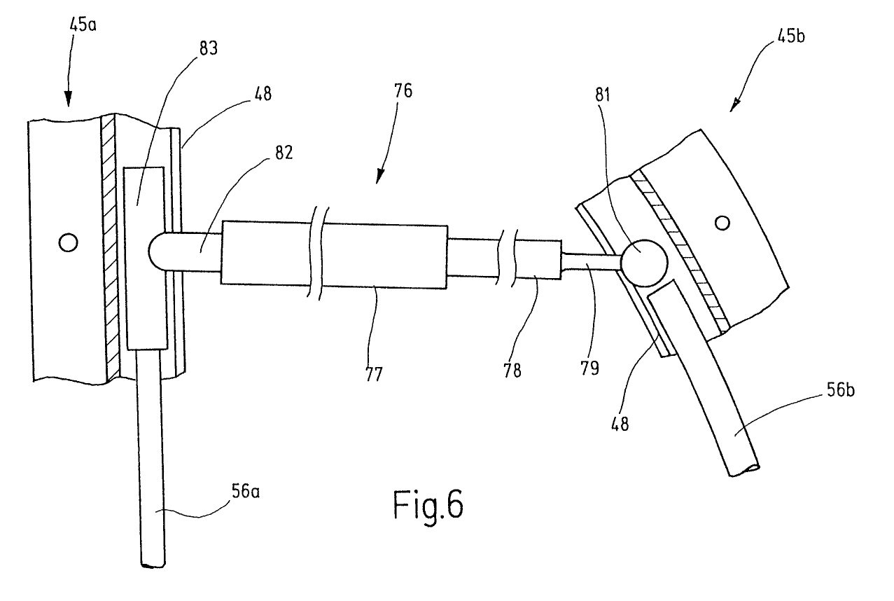

In FIGS. 5 and 6, an embodiment for a side window roll-up blind 30 is depicted which has two guide rails 45a and 45b. The guide rails 45a and 45b have the same shape in cross section, as is thoroughly explained in connection with FIG. 3. The guide rail 45a runs essentially straight in correspondence to the course of the front window frame edge 25, while the back guide rail 45b is aligned with a strong curve in the direction toward the guide rail 45a. Such contours occur, for example, in coupes.

In order to guide the blind material 31 faultlessly between these two guide rails 45a and 45b, the blind material 31 contains in the vicinity of its upper edge 43 a flexible tubular pocket 75 that lies parallel to the winding shaft 34. Through the pocket 45, a tilt holder 76 is lead, which is shown in detail in FIG. 6, which also makes evident the interplay with the guide rails 45.

The tilt holder 76 is composed of two tilt holder members 77 and 78 telescopically movable against one another. The tilt holder piece 77 is a cylindrical tube inside which the tilt holder member 78 is longitudinally guided. At its free end, the tilt holder member 78 goes over into a cylindrical neck 79, which carries a ball 81 on its free end. The ball 81 corresponds in its diameter to the diameter of the clear inner space of the guide groove 46 of the guide rail 45b. It cannot emerge through the slot 48.

The left end of the tilt holder member 77 plugs on a cylindrical pin 82 which stands radially away from a straight cylindrical guide slide 83. The guide slide 83 is freely shiftable in the clear interior space of the guide groove 46 of the guide rail 45a, the pin 82 extending outward through the slot 48.

In each of the two guide rails 45a and 45b, an actuating member 56a or 56b, respectively, runs, the diameter of which is greater than the width of the respective slot 48, wherewith the actuating member 56b is compelled to follow the course of the guide rail 45b and cannot take a short cut by emerging from the slot 48.

The winding shaft 34 and its support are again formed as in the earlier described embodiments. Since the course of the guide rail 45b is arcuately curved, the movement speed of the actuating member 56b does not stand in any constant relation to the movement speed of the actuating member 56a. The two actuating members 56a and 56b are driven therefore by separate motors, in which arrangement the motor that drives the actuating member 56b for the curvilinearly running guide rail 45b is regulated in a purposeful manner. It is a matter here, for example, of a stepper motor controlled by a microprocessor.

For the reeling out of the blind material 31, the two motors are set in operation, and thereupon thrust forward the actuating members 56a and 56b allocated to them in the respectively guide rails 45a and 45b, and there they come into engagment on the one hand with the slide 83, and also with the ball 81 bluntly adjacent. The tilt holder 76 is steadily aligned parallel to the winding shaft 34, and thrust away from that winding shaft 34.

In the vicinity of the winding shaft 34, the two guide rails 45a and 45b have the greatest distance from one another, for which reason the tilt holder 76 is correspondingly extended in length, and projects from the tubular pocket 75. The further the blind material 31 approaches the drawn-out end position, the closer its rear edge 42 approaches the guide rail 45b. The tilt holder 76 is shortened correspondingly. In the end position, the blind material 31 completely fills the space between the guide rails 45a and 45b, and thus completely shades off the side window concerned.

So that the tilt holder 76 will still have a technically useful length, even with completely extended blind material 31, the pocket 75 is retracted over a short distance with respect to the upper edge 43, as shown. The space above the tubular pocket 75 can be filled by a correspondingly rigid mold part of the blind material 31.

Similarly, as explained before, the winding shaft is retracted with respect to the lower window edge 24, and, namely, by the distance that separates the tubular pocket 75 from the upper edge 43, so that in no case are the ends of the tilt holder 56 drawn out downward from the guide rails 45a and 45b.

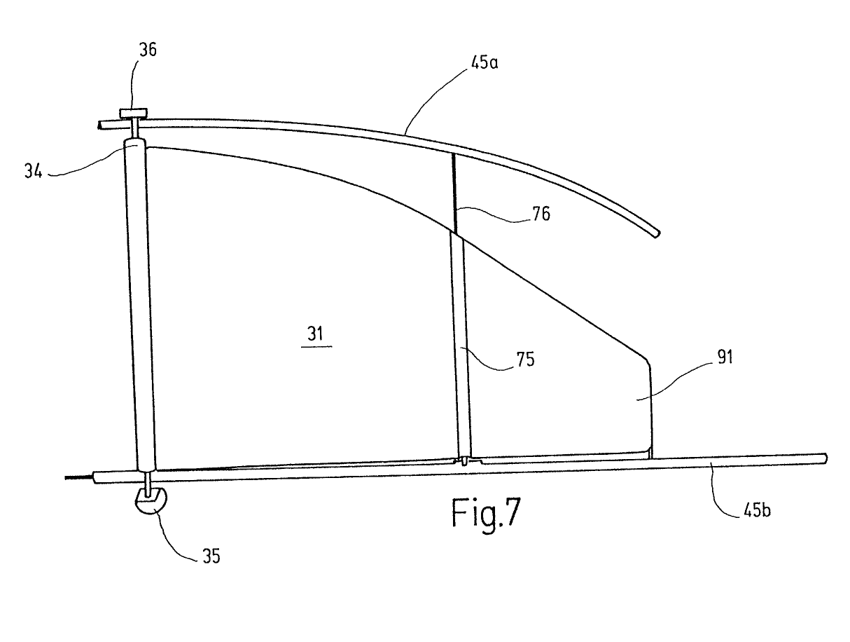

While in the embodiment according to FIG. 5, as shown, the winding shaft 34 runs parallel to the lower window edge, FIG. 7 shows an embodiment in which the winding shaft 34 is aligned vertically and thus lies parallel to the B-column 3. Here, too, two guide rails 45a and 45b are used. The guide rail 45a extends parallel to the lower window edge 24, while the upper guide rail 45b follows the course of the upper window edge 26 or, respectively, a part of the rear window edge 23. The cross sectional shape of the upper guide rail 45b is identical with the cross sectional shape of the guide rail 45 according to FIG. 3, while the lower guide rail 45a has back-gripping grooves 85 and 86 that are continuous in lengthwise direction. The grooves 85 and 86 open upward over a continuous groove slot 87 or 88, respectively. Otherwise there is no difference with the guide groove 45a.

The tilt holder 76 differs from the tilt holder 76 according to FIG. 6 for the side window roll-up blind 30 according to FIG. 5 only in the circumstance that instead of the cylindrical guide slide 83, a ball 89 is used, similar to the ball 81. The receiving pocket 75 for the tilt holder 76 again lies parallel to the winding shaft 34 and consequently it is located at a distance from the rear edge 42 of the blind material 31. On the rear edge 42 of the blind material 31, a further tubular pocket 91 is present in which a tilt holder 92 is inserted which is constructed as a radially way-standing arm of a guide slide 93. The guide slide 93 runs in a groove 85, while the ball 89 slides through the groove 86.

For the reeling-out of the blind material 31, only one actuating member 56 is present, which runs in the groove 85 and cooperates with the slide 43. For the reeling-out of the blind material 31, the drive motor is set in operation and the actuating member is advanced in the groove 85 in the direction toward the rear of the vehicle. There the slide 83 is carried along, and over it the rear edge of the blind material 31.

In the rest state, the blind material 31 is nearly completely wound on the winding shaft 34. Also the pocket 75 with the tilt holder 76 is present in the wound-up ball and only the slide 93 remains in its guide groove 85.

As soon as the slide 93 is correspondingly far advanced and the tilt holder begins to run off from the winding shaft 34, it is provided that by a threading arrangement (not shown) the balls 81 and 89 seated on the two ends of the tilt holder 76 are threaded into the guide grooves 86 and 46, respectively.

In both cases, the tilt holder 76 provides for an adequate stabilization of the two edges of the blind material 31, which extend at a right angle or obliquely to the tilt holder 76.

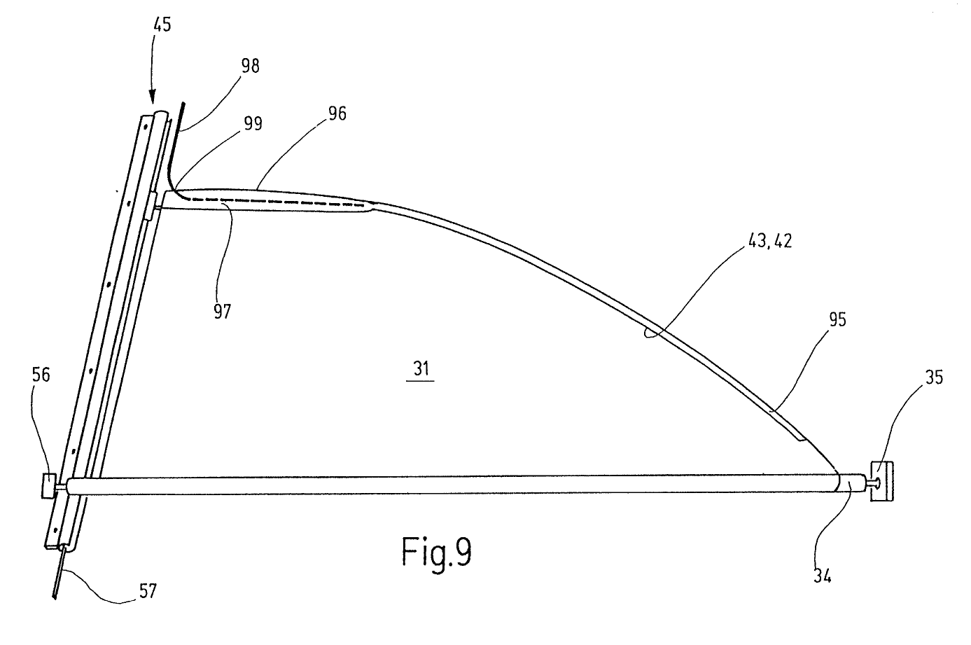

Another form of reinforcement of the blind material edge is shown in FIG. 9. This embodiment resembles the embodiment according to FIG. 5, with the restriction that only the guide rail 45a is present. The blind material 41 or 42 lying away from the winding shaft 34 is provided over a corresponding interval with a tubular pocket 95 which follows the outer contour. On the upper left end, the tubular pocket 95 goes over into a rigid-form contour part 96 which contains an interior space 97 which is aligned with the tubular pocket 95. For the stabilization of the unguided edge of the blind material 31, an elastically flexible plastic wire 98 is provided, which is fastened beside the guide rail 45 to the upper end of the window, and, namely, in such manner that by reason of its clamping it would run parallel to the guide rail 45. Through an opening 99, the plastic wire 98 leads into the mold piece 97 and from there onward into the tubular pocket 95.

In the reeling-out and reeling-in of the blind material 31, the plastic wire slides into the pocket 95 over the molded piece 97 that serves as leading member, and in this manner it stabilizes the border in the corresponding region. With a drawn-up side window roll-up blind 30, a corresponding portion of the elastic wire lies parallel to the guide rail 45 while a short end remains afterward as before, lying in the form part 96 as well as the tubular pocket.

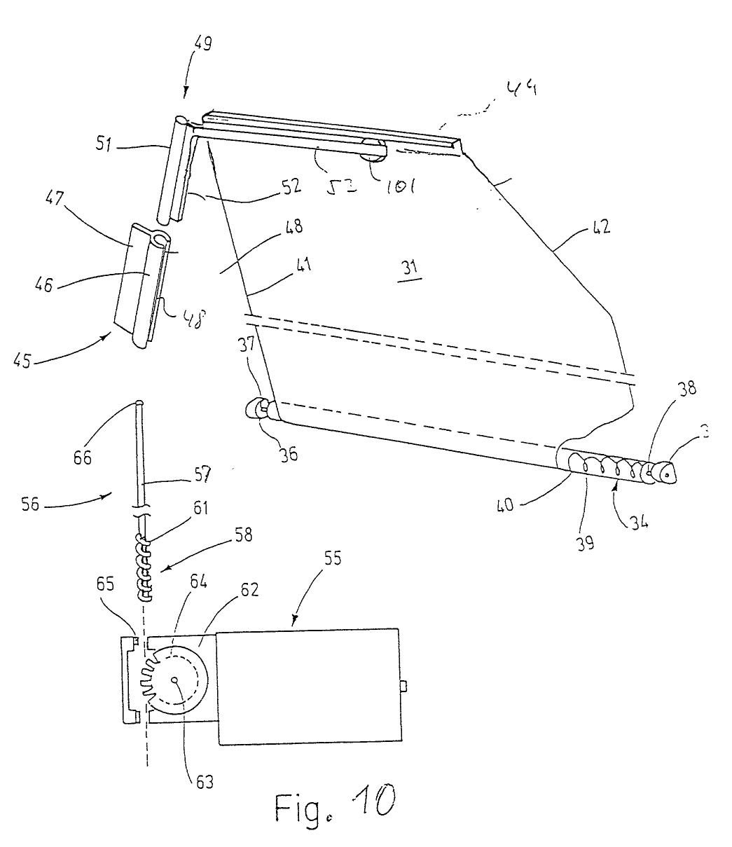

In FIG. 10, a side window roll-up blind 30 is depicted which has a construction very similar to that of the side window roll-up blind 30 according to FIG. 3. The essential difference lies in the border reinforcing strip 44, which is formed by a downward-open U-shaped strip. In the strip 44, a roller 101 runs which is rotatably borne on the free end of the extension 53. With this arrangement not only, as in the embodiment according to FIGS. 2 to 3, can a displacement of the border reinforcing strip 44 parallel to the extension 53 be compensated, but in addition also an angular change.

Such an angular change arises when the guide rail 46, because of the course of the window frame edge concerned, runs not straight, but in a curve, and for this reason the slide 49 in the guide rail 45 takes on the extension 53 a direction in which, dependent on position, it encloses an angle with the winding shaft 34 that is different from zero and which changes steadily in the movement of the blind material 31 relative to it.

The kinematic reversal would likewise be possible, in as much as the roller 101 is mounted on the border reinforcement strip 44, while the extension 53 has an upward-open U-shaped profile.

On which combination of the disclosed features a designer decides, lies at his option and depends above all on the border conditions available, such as window size, window proportions and window geometry, on the space in the side lining or inside the door, and the like. Moreover, it is obvious that the side window roll-up blinds shown are by no means restricted to uses inside of a rear side door in four-door passenger cars. The side window roll-up blind of the invention can be directly implemented also in two-door car body shapes, as it is installed behind the rear side lining of the car body or behind the lining of the B-column. It is also possible to integrate the side window roll-up blind into the driver-side door or into the passenger's door. Merely in order to restrict the number of examples of execution to a reasonable degree, there are described exclusively variants in association with a rear vehicle door for the rear passengers.

A side window roll-up blind for motor vehicles has a winding shaft which is preferably rotatably borne behind the side lining of the door or of the B-column. Through a slot in the door there can be drawn out a blind material which covers the window. For this purpose an actuating member engages on the edge of the blind material which covers the greatest distance. The actuating member is a linear element which, depending on the embodiment, is either pull-proof or resistant to pressure. The blind material itself can be held tensioned beside the window with the aid of at least one guide rail or of one or two pressure-resistant, or bending-resistant actuating members.

1. A side window roll-up blind for a motor vehicle having at least one side window that is bounded by a lower window frame edge which extends approximately horizontally and at least one lateral window frame edge which extends approximately vertically, the roll-up blind comprising:
a rotatable winding shaft,
a blind material that is movable between a reeled-in position and a reeled-out position and at least a portion of which has a shape corresponding at least approximately to the shape of the side window, the blind material having an outer peripheral border with a first portion which is fastened to the winding shaft and a second portion which lies away from the winding shaft,
an actuating mechanism that is connected to the second portion of the outer peripheral border of the blind material, and
an electrically operable drive mechanism for moving the blind material between the reeled-in and the reeled-out positions.

2. A side window roll-up blind according to claim 1, wherein the winding shaft extends in a vertical direction and is arranged beside the lateral window frame edge.

3. A side window roll-up blind according to claim 1, wherein the winding shaft extends in an approximately horizontal direction and is arranged underneath the lower frame edge of the window.

4. A side window roll-up blind according to claim 1, wherein the winding shaft has an associated roll-up mechanism which causes the blind material to wind on the winding shaft in a truncated cone-shape.

5. A side window roll-up blind according to claim 1, further including a guide rail.

6. A side window roll-up blind according to claim 1, further including two guide rails which in at least in one portion of their length extend at least approximately parallel to one another.

7. A side window roll-up blind according to claim 5, wherein the guide rail extends in a horizontal direction.

8. A side window roll-up blind according to claim 5, wherein the guide rail extends parallel to the lower window frame edge.

9. A side window roll-up blind according to claim 5, wherein the guide rail extends in a vertical direction.

10. A side window roll-up blind according to claim 5, wherein the guide rail extends parallel to the lateral window frame edge.

11. A side window roll-up blind according to claim 1, wherein the roll-up blind does not include any guide rails.

12. A side window roll-up blind according to claim 1, wherein the blind material includes a border reinforcing element in the second portion of the outer peripheral border.

13. A side window roll-up blind according to claim 12, wherein the border reinforcing element is flexible.

14. A side window roll-up blind according to claim 12, wherein the border reinforcing element is resistant to bending in a plane defined by the blind material in the reeled-out position.

15. A side window roll-up blind according to claim 12, wherein at least one portion of the border reinforcing element serves as pull rod.

16. A side window roll-up blind according to claim 12, wherein the winding shaft is arranged laterally offset with respect to the lower window frame edge by an amount corresponding to the length defined by the projection the border reinforcing element onto a straight line perpendicular to the winding shaft.

17. A side window roll-up blind according to claim 5, the blind material has an associated tilt holder which is guided on an end side in the guide rail.

18. A side window roll-up blind according to claim 17, wherein the tilt holder is guided on both ends in guide rails.

19. A side window roll-up blind according to claim 17, wherein the tilt holder is telescopically adjustable in length.

20. A side window roll-up blind according to claim 5, further including a slide element guided in the guide rail and an extension member which is fastened to the slide element, the second portion of the outer peripheral border of the blind material being connected to the slide element and connection member by a connecting element.

21. A side window roll-up blind according to claim 20, wherein the connecting element comprises two rails slidable which are into one another.

22. A side window roll-up blind according to claim 20, wherein the connecting element comprises a rail and a roller that is guided and runs in the rail.

23. A side window roll-up blind according to claim 20, wherein the second portion of the outer peripheral border of the blind material is connected in longitudinally slidable relation with the extension member.

24. A side window roll-up blind according to claim 1, wherein the actuating mechanism includes a linear-form pressure member which is guided in a sleeve such that the pressure member is resistant to compression.

25. A side window roll-up blind according to claim 1, wherein the actuating mechanism includes a bending- resistant rod having a free end which is connected with the outer peripheral border of the blind material, the bending-resistant rod being longitudinally guided in a fixed guiding arrangement which guides the bending-resistant rod for movement in a direction substantially at a right angle to the longitudinal axis of the winding shaft.

26. A side window roll-up blind according to claims 25, wherein the bending-resistant rod is coupled with a linear-form pressure member.

27. A side window roll-up blind according to claim 20, wherein the actuating mechanism includes a linear-form pressure member which is guided in a sleeve such that the pressure member is resistant to compression and the linear-form pressure member is coupled with the slide member.

28. A side window roll-up blind according to claim 17, wherein the actuating mechanism includes a linear-form pressure member which is preferably guided in a sleeve such that the pressure member is resistant to compression and the linear-form pressure member is coupled with the tilt holder.

29. A side window roll-up blind according to claim 24, wherein the linear-form pressure member includes a gear at an end thereof which positively couples the pressure member with a gear wheel of a drive motor.

30. A side window roll-up blind according to claim 1, wherein the actuating mechanism includes a cable.

31. A side window roll-up blind according to claim 1, wherein the actuating mechanism includes two cables each of which is driven at a different speed.

32. A side window roll-up blind according to claim 1, wherein the drive mechanism includes a spring.

33. A side window roll-up blind according to claim 32, wherein the spring comprises a spring motor that is coupled with the winding shaft and pre-stresses the winding shaft in a direction so as to move the blind material towards the reeled-in position.

34. A side window roll-up blind according to claim 32, characterized wherein the spring is coupled with the blind material by the actuating mechanism and pre-stresses the blind material in the direction of the reeled-out position.

35. A side window roll-up blind according to claim 1, wherein the drive mechanism includes at least one gear motor.

36. A side window roll-up blind according to claim 35, wherein the gear motor is coupled with the winding shaft.

37. A side window roll-up blind according to claim 35, wherein the gear motor is coupled with the blind material through the actuating mechanism.

38. A side window roll-up blind according to claim 35, wherein the roll-up blind includes two actuating mechanisms and the gear motor drives each actuating mechanism at a different speed.

39. A side window roll-up blind according to claim 38, wherein the drive mechanism includes two controlled motors which drive the two actuating mechanisms at different speeds.

40. A side window roll-up blind according to claim 39, wherein the motors comprise microprocessor-controlled stepper motors.
